(19) United States
(12) Patent Application Publication
(10) Pub. No.: US 2009/0084890 A1
(43) Pub. Date: Apr. 2, 2009

(54) Aircraft

(76) Inventor: Gert Joachim Reinhardt, Oetigheim (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/226,650

(22) PCT Filed: Apr. 25, 2007
(86) PCT No.: PCT/EP2007/054030

§ 371 Date: Oct. 24, 2008

(30) Foreign Application Priority Data
Apr. 26, 2006 (DE) 102006019300.8

(51) Int. Cl. B64C 27/28

(52) U.S. Cl. 244/12.4

(57) ABSTRACT

An aircraft, in particular a VTOL craft, comprises a fuselage supporting at least a pair of wings. According to the disclosure, several propeller devices are connected to the fuselage and optionally to the pair of wings. The propeller devices may be pivoted about pivot axes independently of each other. The pivot axes are at an angle ≠0° to each other.

### BACKGROUND

1. Field of the Disclosure

The disclosure is directed to an aircraft, in particular an aircraft called a vertical take-off aircraft that can take off in a vertical direction.

2. Discussion of the Background Art

With small transport aircrafts, for example, there is a problem that they always require a runway for landing and take-off, respectively. This entails a substantial place requirement. Moreover, it is necessary to construct corresponding airports. It is impossible for conventional aircrafts to take off or land outside these airports. This is only possible for helicopters which, however, have low transport capacity relative to their own weight. As a particular disadvantage, the fuselage of helicopters is inclined when flying horizontally. A helicopter hovering in a space, for example, must first be inclined by adjusting the rotor blades so as to then fly horizontally or in a direction having a horizontal component. Therefore, it is extremely difficult to exactly position a helicopter in a space.

Further, a vertical lift-off is possible with so-called quadrocopters. Quadrocopters are steered by changing the relative rotational speed of individual rotors with respect to each other. Due to the different speeds of rotation of the rotors, the fuselage is tilted. Therefore, it is also difficult to position quadrocopters accurately.

An aircraft with a propeller drive is known from GB 9 35 715. The individual propeller drives may be pivoted about a horizontal axis in order to change the advance direction of the individual propeller drives. The individual propeller drives are pivoted by motors via an intermediate transmission. Pivoting the individual propeller means thus requires additional energy.

It is the object of the disclosure to provide an aircraft which, in particular, is adapted to be accurately positioned in a space.

### SUMMARY

According to the disclosure, the drive means of the inventive aircraft are configured such that to perform a horizontal flight or a flight with a horizontal component, no or only a slight tilting or inclining of the fuselage is required. To this avail, the aircraft of the present disclosure comprises at least two drive means, wherein at least two of the drive means are pivotable around at least one pivot axis. According to the disclosure, the two pivot axes are arranged at an angle other than zero with respect to each other. Thus, the two pivot axis are not parallel to each other. In a preferred embodiment, the aircraft has a plurality of drive means that are at least partly pivotable about, preferably, two pivot axes. It is essential to the disclosure that at least two pivot axes are provided that are not orientated in parallel to each other. In a particularly preferred embodiment, the aircraft according to the disclosure comprises at least one drive means that is pivotable about two or three of its pivot axes. With a pivotability about three different axes, the drive preferably is a fully gimbal-mounted drive. However, it is possible to omit one or two of the pivot axes, if a plurality of drive means is provided, each pivotable about different pivot axes that are not parallel to each other.

It is an essential aspect of the disclosure that each drive means comprises at least two thrust means, such as propeller means. The at least two thrust means are connected with a control means. Using the control means, the thrust force of the individual thrust means can be adjusted separately. With a plurality of thrust means comprised into a drive means, the thrust force of at least two thrust means can be adjusted separately. If the thrust means are propeller means, the thrust force is adjusted by varying the rotational speed of the propeller. Since the drive means, i.e. the at least two thrust means of the respective drive means, is pivotable about at least one axis, the drive means is pivoted automatically by variation of the thrust forces. For this purpose, at least two of the thrust means are arranged on different sides of the pivot axis.

By adjusting the thrust force accordingly, e.g. by varying the rotational speed of the propeller means, a moment will be generated about the pivot axis. Since no moments other than frictional moments in the bearings or moments caused by airflow act on the pivot axis, this causes an automatic pivoting of the drive means and thus a change in the thrust direction relative to each individual drive means. It is not necessary to provide a separate pivot means, in particular an electric motor, for pivoting the drive means. According to the disclosure, the drive means are freely pivotable about the respective pivot axes. As provided by the disclosure, the drive means are swivelled exclusively by changing the thrust forces of individual thrust means.

Since the individual thrust means of the plurality of drive means are separately drivable at least in part, the aircraft of the disclosure can be steered in a simple manner.

The thrust means may be propeller means. Further, they may also be rotors or jet engines.

If the pivotable drive means with a plurality of thrust means are propeller means, in particular, each propeller means comprises a thrust direction that corresponds to the rotational axis of the propeller means. With a horizontal rotational axis of the propeller means, the thrust will be horizontal. When the rotational axis is orientated in parallel to the longitudinal direction of the fuselage, the thrust will be in the longitudinal direction of the aircraft. By pivoting the propeller means from this position about a vertical pivot axis, a lateral thrust may be achieved with respect to the longitudinal direction of the aircraft. Pivoting about a horizontal pivot axis, which is especially perpendicular to the longitudinal direction of the aircraft, the aircraft may be moved along a descending or an ascending trajectory without causing a substantial inclination of the fuselage. Since at least one drive means of the aircraft, which in a particularly preferred embodiment is a drive means with at least two thrust means such as propeller means, is pivotable about two pivot axes, the spatial position of the aircraft can be changed without tilting the fuselage in the process. If any, a slight inclination of the fuselage may occur.

In a particularly preferred embodiment at least one, preferably all drive means comprise at least three, preferably at least four thrust means. Here, the thrust means are arranged on the preferably two pivot axes such that, relative to each of the two pivot axes, at least one of the thrust means is provided on either side of the pivot axis. With two pivot axes perpendicular to each other and four thrust means, such as propeller means, one thrust means is thus arranged in each quadrant defined by the pivot axis. In this respect, it is particularly preferred that the individual thrust means can be arranged such that the thrust directions of the individual thrust means are parallel to each other, wherein the thrust directions may oppose each other. Preferably, the thrust directions of the individual thrust means of a drive means are always in parallel to each other, regardless of the pivot position of the drive means.

The aircraft of the disclosure comprises a fuselage supported by a least one pair of wings. The aircraft may comprise one or a plurality of separate pairs of wings. However, separate pairs of wings may also be omitted or be integrated in a propeller means. Here, the rotor blades of the propeller serve as individual wings. Thus, the fuselage is supported by a wing element which may be formed by individual wings, especially individual rotor blades of a propeller means, but also by pairs of wings. A plurality of propeller means are connected with the fuselage and/or the wings. At least one, preferably each drive means having a plurality, in particular four thrust means, such as propeller means, is pivotable with respect to the fuselage and the wings, respectively. According to the disclosure, the drive means are pivotable independently If only one instead of two pivot axes are pivotable, the pivoting of the non-pivotable axis may be shifted to the drive means that comprise corresponding pivoting means. In particular in a standing aircraft, the pivot axes are a vertically and a horizontally extending axis. In particular, one of the axes is orientated perpendicular to the fuselage, while the second axis is directed perpendicular to that axis. Both pivot axes are preferably coupled such that the orientation of the second pivot axis is changed by rotating the first pivot axis. Providing two pivot axes per drive means, as contemplated in a preferred embodiment of the disclosure, allows to rotate the drive means, e.g., from a position, where the thrust direction is vertical, by 90°, for example, about a first pivot axis so that the thrust direction is horizontal. Due to the pivotability about the second pivot axis, the thrust direction can be changed by pivoting the drive means from a position parallel to the fuselage to a position perpendicular to the fuselage. Controlling the two pivot axes appropriately allows to pivot the drive means into any optional spatial position. This requires a pivoting means for pivoting the drive means about a pivot axis. To allow this, the pivoting means must apply a high torque. Therefore, it is particularly preferred to provide at least two drives or propellers per drive means. By controlling the drives or propellers differently, i.e. in particular by operating the propellers at different rotational speeds, the drive means is automatically pivoted about the pivot axis. An additional pivoting means, such as an electric motor, for pivoting the drive means is thus not required.

Preferably, all drive means may be pivoted independently into different spatial positions, with four thrust means preferably being provided. In particular, each drive means comprises a plurality, especially four thrust means, such as propeller means. With an appropriate orientation of the drive means, the aircraft may first take off and land vertically. Thus, an exclusively vertical direction of movement is possible for take-off and landing. By correspondingly controlling the pivoting of the individual drive means, the aircraft can be moved optionally in space after take-off. In this respect, it is essential to the disclosure that due to the fact that the drive means can be pivoted individually, the total centre of gravity of the aircraft changes only slightly. This guarantees a good maneuverability of the aircraft. The aircraft of the present disclosure can thus take off and land vertically, stand in a horizontal plane and fly along a horizontal plane without any inclination or at least with a very slight inclination. This property achieved by the pivotability of the drive means about two axes clearly distinguishes the aircraft according to the disclosure from a helicopter.

With the aircraft of the disclosure, the fuselage which may be deigned as a freight container or may receive a freight container, for example, can thus be positioned exactly in space. In particular, a container can be set on the ground or lifted up precisely.

Due to the fact that, according to the disclosure, a plurality of drive means are provided, especially at a distance from the fuselage, a pivoting of individual drive means only negligibly changes the position of the total centre of gravity. As an advantage thereof, no pivoting of the transported load occurs and special positioning means and/or cranes for the positioning of containers relative to the fuselage can be omitted.

By providing, as proposed by the disclosure, a plurality, especially four, drive means that are each freely pivotable about two axes, all flight maneuvers can be performed with exclusive use of the drive means. Additional drive means are required, if at all, for take-off and landing, if great weights have to be transported.

Preferably, the drive means are arranged laterally beside the fuselage, especially at a distance from the pair of wings. Preferably, two drive means are provided on each side of the fuselage. With four drive means, two drive means are arranged on each side of the fuselage. Should two pairs of wings be provided, one drive means is preferably arranged on each side of the fuselage between the two pairs of wings, respectively.

The drive means are supported by a support rack at the fuselage. The drive means are preferably connected with the fuselage through a frame-shaped support rack, which frame-shaped support rack, in a particularly preferred embodiment, comprises longitudinal beams extending in particular in the longitudinal direction of the fuselage and being connected with the wings. The connection between the longitudinal beams and the wings is preferably realized in the outer portion of the wings. Should several pairs of wings be provided, the longitudinal beams are preferably connected with the wings arranged between drive means. In this manner, a light-weight support rack can be realized.

In a particularly preferred embodiment, at leas a part of the support rack is formed as a pivot shaft for pivoting the drive means about the corresponding pivot axis. Thus, the pivot shaft is a supporting component of the support rack and both serves a supporting function and the pivoting of the drive means. This allows for a further reduction of the total weight, since no separate pivot shaft is required.

Since the thrust energy to be applied is highest upon take-off and landing, additional drive means, such as additional propellers, are preferably provided. In a preferred embodiment, these are not pivotable and may therefore be of an extremely light structure. Since, in a preferred embodiment, the aircraft of the disclosure is a vertical take-off aircraft, the thrust direction of these additional propellers is directed vertically. In particular, the additional propellers are arranged near the fuselage and are preferably integrated at least in part in the fuselage. For example, it is possible to arrange the additional propellers behind openable and closable fuselage parts, such as flaps, sliding doors and the like, since the additional propellers are required only for take-off or landing. After take-off or landing, the additional propellers can be switched off and the corresponding flaps, doors or the like can be closed again. Thus, good aerodynamics can be obtained during flight, independent of take-off and landing. Further, the occurrence of undesired air turbulences and interfering air flows is avoided.

Preferably, the propeller means are propellers driven by electric motors, where, in a particularly preferred embodiment, the aircraft carries generators, especially linear generator, for generating electric energy. This allows for an extremely efficient energy efficiency so that a very good ratio of thrust energy and weight can be obtained. A combination of a motor and a generator, which can immediately be used as a propeller drive, is described in DE 10 2004 048 109, for example.

### BRIEF DESCRIPTION OF THE DRAWINGS

The following is a detailed description of the disclosure with reference to a preferred embodiment and to the accompanying drawings.

In the Figures:

FIG. 1 is a schematic top plan view on a schematic diagram of an aircraft of the present disclosure,

FIG. 2 is a schematic perspective view of a second embodiment of the aircraft of the present disclosure during take-off or landing, and

FIG. 3 is a schematic perspective view of the aircraft illustrated in FIG. 2 during a horizontal flight,

FIG. 4 is a schematic perspective view of a third embodiment of the aircraft of the present disclosure,

FIG. 5 is a schematic perspective view of a fourth embodiment of the aircraft of the present disclosure.

### DETAILED DESCRIPTION OF THE PREFERRED EMBODIMENT

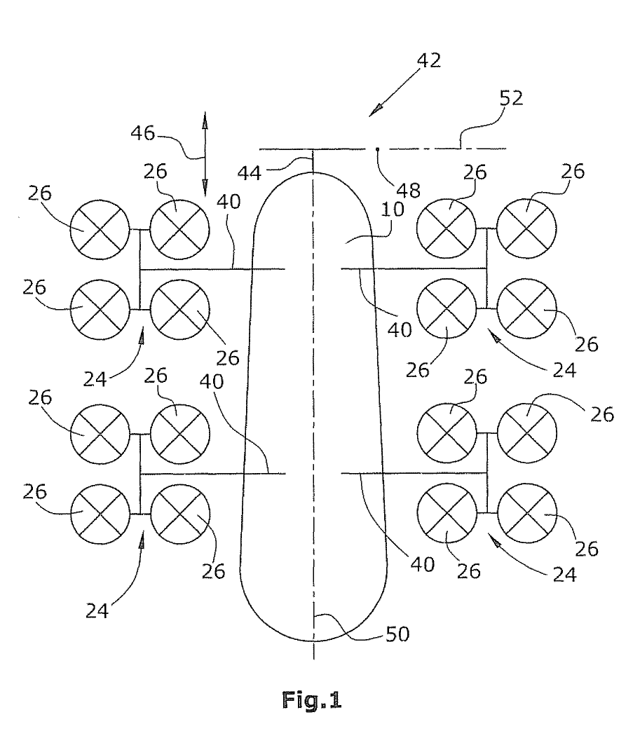

The schematic diagram of the disclosure shown in FIG. 1 illustrates the aircraft of the present disclosure in a simple basic embodiment. Here, the fuselage 10 is connected with four drive means 24 which, in the embodiment illustrated, each have four individual propeller means 26. The individual propeller means or propellers 26 are connected with the fuselage 10 through supports 40. The propellers 26 exclusively allow for a vertical thrust to be generated, i.e. a thrust especially required for take-off and landing. A movement from the vertical direction is possible by means of another drive means 42 that, for example, only has one propeller means 26. In the embodiment illustrated. The propeller means 42 is arranged such that the rotational axis corresponds to the support 44 illustrated. The support 44 is directed horizontally. Using the drive means 42 in the position illustrated in FIG. 1, a thrust may be generated in the direction of the arrow 46. In a preferred embodiment, the drive means 42 is pivotable about a horizontal pivot axis. Thus, the horizontal pivot axis extends perpendicular to the plane of drawing. In FIG. 1, the pivot axis is defined by the point 48. Moreover, the propeller means 42 is pivotable about a horizontal pivot axis 52 extending perpendicular to the longitudinal direction 50 of the aircraft. For pivot movements about the pivot axes 48, 52, the drive means 42 preferably comprises four thrust means 26 that are arranged and pivotable as will be explained hereinafter.

Since it is possible to pivot the drive means 42 about the pivot axes 48 and 52, the fuselage 10 of the aircraft can be positioned exactly in any spatial position, with no or only a slight inclination of the fuselage 10 when changing position.

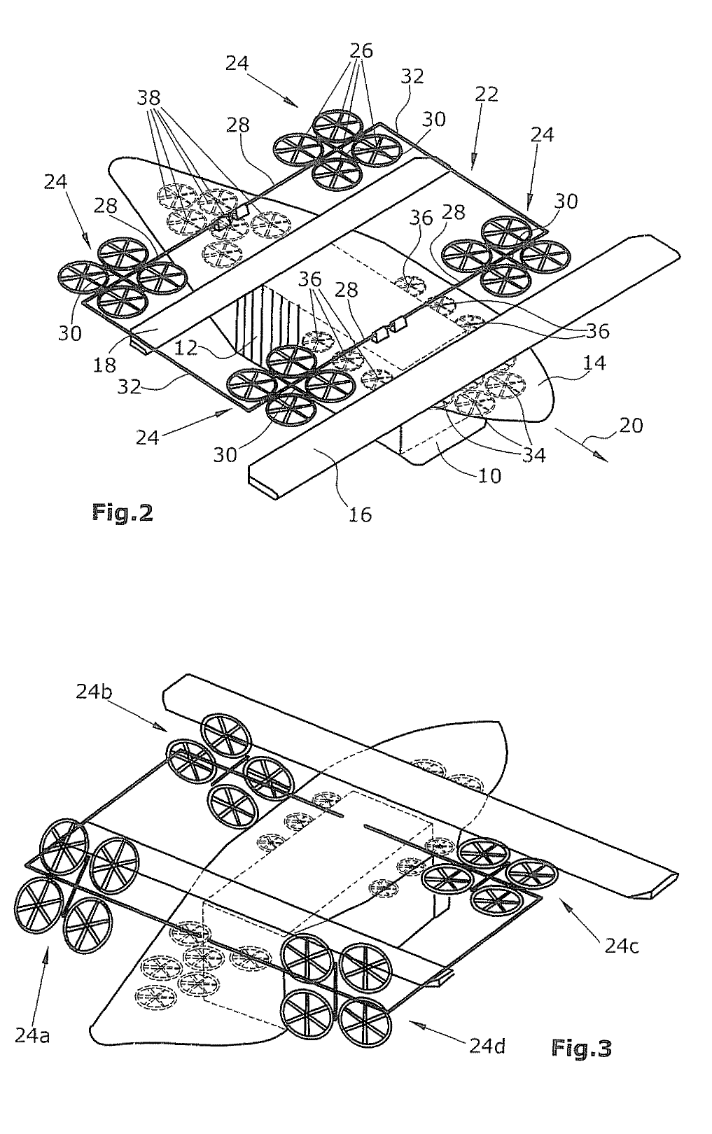

In a second preferred embodiment of the disclosure, which will be described hereunder with reference to FIGS. 2 and 3, identical and similar components are identified by the same reference numerals.

The aircraft, especially configured as a transport plane, has a fuselage 10 carrying a container 12 that may be a conventional transport container. In the present case, the container especially is a part of the fuselage 10. In the embodiment illustrated, two pairs of wings 16, 18 are arranged at an upper part 14 of the fuselage 10. The longitudinal direction of the fuselage or the frontward movement is indicated by the arrow 20.

Moreover, four drive means 24 are connected with the fuselage 10 through a support rack 22 which, in the embodiment illustrated is frame-shaped, in particular rectangular. In the embodiment shown, each of the drive means 24 comprises four propellers 26. The entire drive means 24 is pivotable about a corresponding pivot axis 28 through a pivot shaft 28. The pivot shaft 28 extend perpendicular to the longitudinal axis 20 of the fuselage so that, with respect to a horizontal flight, the individual drive means 24 are pivotable about a horizontal axis 28. Such a pivoting is illustrated in FIG. 3 for the drive means 24a.

Each drive means 24 is pivotable not only about a pivot axis 28, but also about a pivot axis 30 arranged perpendicular to the pivot axis 28. A corresponding pivoting only about the pivot axis 30 is shown in FIG. 3 for the drive means 24b.

Further, FIG. 3 illustrates a drive means 24c that is pivoted neither about the pivot axis 28, nor about the pivot axis 30. The drive means 24d is first pivoted by 90° about the pivot axis 28 and is then pivoted additionally by a small angle about the pivot axis 30.

The support frame 22 has cross beams designed as pivot shafts 28, as well as longitudinal beams 32. In the embodiment illustrated, the longitudinal beams 32 are respectively connected with the wings 18 of the rear pair of wings at the outer part thereof. The longitudinal beams 32 exclusively serve to stiffen the support rack 22, but are not ultimately necessary.

As is particularly evident from FIG. 2, the possibility to pivot the individual drive means 24 independently about two axes 28, 30 makes it possible, implementing a control device not illustrated, to control the propeller means such that all flight maneuvers can be realized using only these drive means 24. Here, no substantial inclination of the entire plane occurs. The position of the total centre of gravity of the aircraft, which is within the container 12, changes only slightly when the individual drive means 24 are pivoted during flight.

Since take-off and landing require great thrust forces, a particularly preferred embodiment provides additional propellers 34, 36, 38. These are especially arranged near the fuselage 10. In a preferred embodiment, the additional propellers 34, 36, 38 are not pivotable, but are always arranged such that their thrust is directed vertically. Here, the additional propellers 36 are situated immediately laterally of the fuselage 10 or the container 12 that forms part of the fuselage. In this case, a plurality of additional propellers 26, especially three, are provided in succession, seen in the flight direction, beside the fuselage 10 or the container 12.

The additional propellers 34, 38 are located in the front and the rear portion of the fuselage. In a preferred embodiment, these are integrated in the fuselage, where the fuselage surface can be closed by providing flaps, doors or other closing means, so that the additional propellers 34, 38 are situated within the fuselage. The corresponding means will be opened only for take-off or landing in order to generate an appropriate thrust in the desired direction. Providing such means for closing the fuselage surface has the advantage of allowing for an aerodynamically favorable surface of the fuselage during flight maneuvers, the more so, since the additional propellers 34, 36, 38 are needed only during take-off, landing or maneuvering in general.

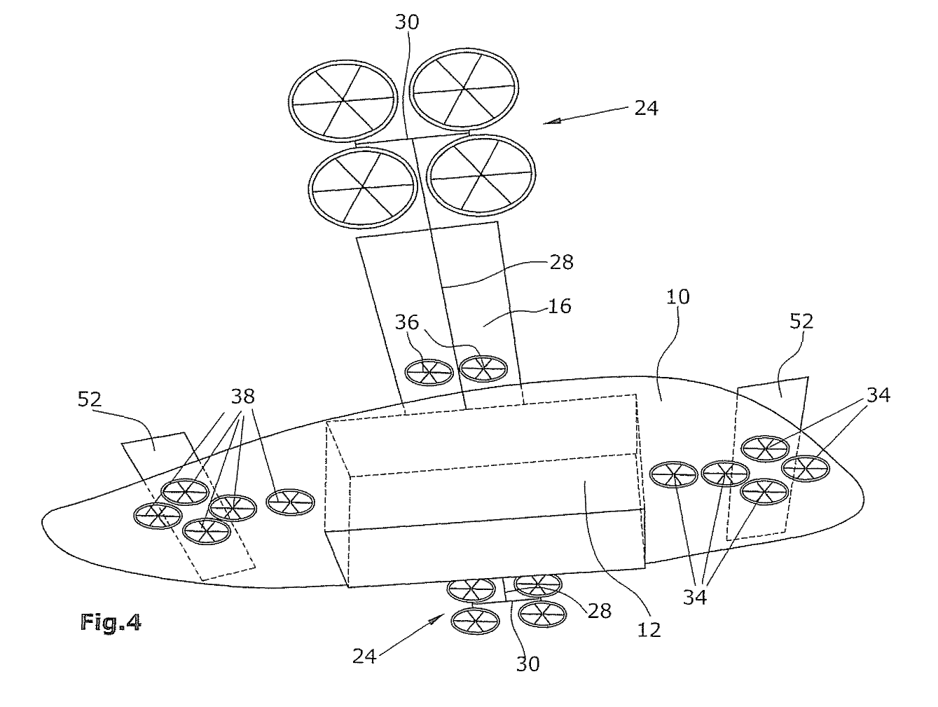

In a third preferred embodiment (FIG. 4), similar or identical components are identified by the same reference numerals.

A substantial difference characterizing the third preferred embodiment of the aircraft according to the disclosure (FIG. 4) is that a central pair of wings 16 is provided. In addition, two auxiliary pairs of wings 52 are arranged at the front and the rear end of the fuselage 10, respectively. The propeller means 36 that exclusively serve for take-off and landing are situated near the fuselage 10 as described in connection with the second embodiment.

A particularly tubular support element 54 is used to provide respective drive means 24 at the fuselage and/or together with the wing 16 on the outside laterally beside the wing. As described in connection with the above embodiment, the drive means 24 are pivotable about two axes to allow a simple maneuvering of the aircraft in space.

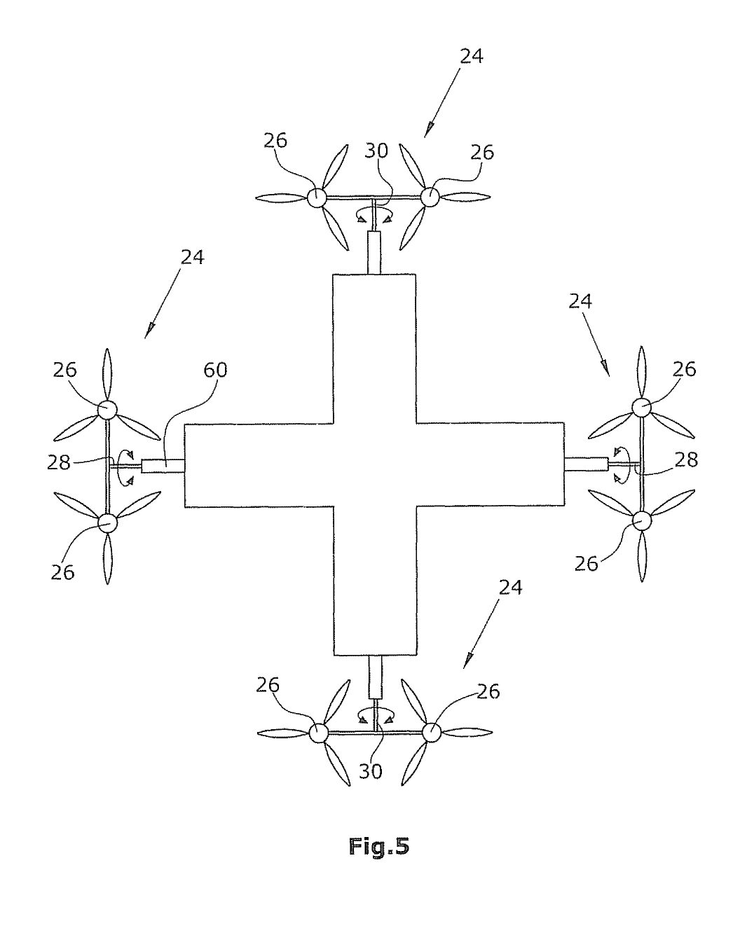

FIG. 5 illustrates four drive means 24 with two propellers, respectively. Both propellers of the drive means 24 are pivotable about a common rotational axis 60. The above explanations are valid for this embodiment as well, since the respective opposite pivot axes 28 and 30 are parallel to each other. The pivot axes 28 are shifted by 90° with respect to the pivot axes 30 so that the same effect is obtained as described above in connection with FIGS. 1 to 4.

In the embodiment illustrated in FIG. 5, the drive means 24 are thus pivotable only about one pivot axis 28 or 30, respectively. The two pivot axes 28 and 30 are arranged under a relative angle not equal to 0°, the angle being 90° in the embodiment illustrated.

Pivoting the drive means 24 about the pivot axes 28 or 30 is effected by driving the individual propellers 26 at different rotational speeds.

1. An aircraft, in particular a vertical take-off aircraft, comprising:
at least one wing element carrying a fuselage, and
at least two drive means connected with the fuselage (10) and/or the wing element, wherein at least two of the drive means are pivotable about a respective pivot axis and the pivot axes are arranged under an angle not equal to 0° with respect to each other,
wherein each drive means comprises at least two thrust means connected with a control means for a separate adjustment of the respective thrust force in order to effect a pivoting of the drive means.

2. The aircraft of claim 1, wherein said at least one of the drive means is pivotable about two pivot axes.

3. The aircraft of claim 2, wherein the two pivot axes are arranged perpendicular to each other.

4. The aircraft of claim 1, wherein the two pivot axes are arranged perpendicular to the thrust direction of the drive means, respectively.

5. The aircraft of claim 2, wherein at least one drive means comprises at least three thrust means.

6. The aircraft of claim 1, wherein the thrust directions of the individual thrust means of at least one per drive means is parallel to each other.

7. The aircraft of claim 1, further comprising a control means for pivoting the drive means such that all flight maneuvers are executable only by means of the propeller means.

8. The aircraft of claim 1, wherein the drive means are located laterally beside the fuselage, especially at a distance from the pair of wings.

9. The aircraft of claim 1, wherein each drive means is connected with the fuselage and/or the pairs of wings through a support rack.

10. The aircraft of claim 9, wherein at least two drive means are connected with the fuselage and/or the pairs of wings through a common support rack.

11. The aircraft of claim 9, wherein the support rack comprises longitudinal beams respectively connected with a pair of wings.

12. The aircraft of claim 9, wherein the support rack has a pivot shaft as a load-bearing component to form one of the two pivot axes.

13. The aircraft of claim 1, wherein the first pivot axis extends perpendicular to the longitudinal direction of the fuselage and is oriented substantially horizontally during flight.

14. The aircraft of claim 12, wherein the first pivot axis carries the second pivot axis.

15. The aircraft of claim 1, further comprising additional drive means for take-off and landing in a vertical direction.

16. The aircraft of claim 15, wherein the additional drive means are not pivotable.

17. The aircraft of claim 15, wherein the additional drive means are arranged close to the fuselage, or are partly integrated in the fuselage.
